(19) United States
(12) Patent Application Publication
(10) Pub. No.: US 2017/0331805 A1
(43) Pub. Date: Nov. 16, 2017

(54) LOCATION-BASED INFORMATION DISTRIBUTION

(71) Applicant: N & M Future, LLC., Mclean, VA (US)

(72) Inventors: Quan Anh PHAM, Mclean, VA (US); Tuan Van DINH, Daklak Province (VN); Hy Nguyen Ngoc LE, Lam Dong Province (VN)

(73) Assignee: N & M Future, LLC., Mclean, VA (US)

(21) Appl. No.: 15/154,188

(22) Filed: May 13, 2016

(51) Int. Cl. H04L 29/06; G06F 17/30; H04L 12/58; H04L 29/08

(52) U.S. Cl. CPC H04L 63/08; H04L 67/306; H04L 67/18; G06F 17/30061; H04L 51/20; H04L 63/104

(57) ABSTRACT

A method of matching geographic information to a requester including matching users subscribed to a service with devices used by the users; receiving and storing geographic information corresponding to locations of the users; receiving content selectively authorized by the users to be shared, and matching the content with the geographic information corresponding to the locations of the users; receiving from a requester a request specific to a location indicated on an electronic map and identifying from the content selectively authorized by the users and based on matched geographic information that matches the location indicated on the electronic map, a subset of the content to provide to the requester in response to the request; and providing, over a communications network, the subset of the content to provide to the requester in response to the request and based on the geographic information that matches the location indicated on the electronic map.

### BACKGROUND

### 1. Field of the Disclosure

The present disclosure relates to the field of information distribution. More particularly, the present disclosure relates to matching information collectors with information sources based on locations correlated with information provided by the sources and sought by the collectors.

### 2. Background Information

Online social networks allow people to connect to those they know in real life, as well as to find others who provide topical information of interest. Social network users can specify a location for content such as by checking in, or by noting a location in a post. Mechanisms for finding information are typically based on preexisting relationships with sources (e.g., using the Facebook™ social network) and/or by searching for content by topic (e.g., using the Twitter™ social network).

### BRIEF DESCRIPTION OF THE DRAWINGS

FIG. 1 shows an exemplary general computer system that includes a set of instructions for location-based information distribution;

FIG. 2 shows an exemplary process for location-based information distribution, according to an aspect of the present disclosure;

FIG. 3 shows an exemplary network for location-based information distribution, according to an aspect of the present disclosure;

FIG. 4 shows an exemplary gridded map, according to an aspect of the present disclosure;

FIG. 5 shows another exemplary gridded map, according to an aspect of the present disclosure;

FIG. 6 shows an exemplary process for location-based information distribution, according to an aspect of the present disclosure;

FIG. 7 shows an exemplary webpage for location-based information distribution, according to an aspect of the present disclosure;

FIG. 8 shows an exemplary webpage for location-based information distribution, according to an aspect of the present disclosure;

FIG. 9 shows an exemplary webpage for location-based information distribution, according to an aspect of the present disclosure; and

FIG. 10 shows an exemplary webpage for location-based information distribution, according to an aspect of the present disclosure.

### DETAILED DESCRIPTION

In view of the foregoing, the present disclosure, through one or more of its various aspects, embodiments and/or specific features or sub-components, is thus intended to bring out one or more of the advantages as specifically noted below.

Methods described herein are illustrative examples, and as such are not intended to require or imply that any particular process of any embodiment be performed in the order presented. Words such as “thereafter,” “then,” “next,” etc. are not intended to limit the order of the processes, and these words are instead used to guide the reader through the description of the methods. Further, any reference to claim elements in the singular, for example, using the articles “a,” “an” or “the”, is not to be construed as limiting the element to the singular.

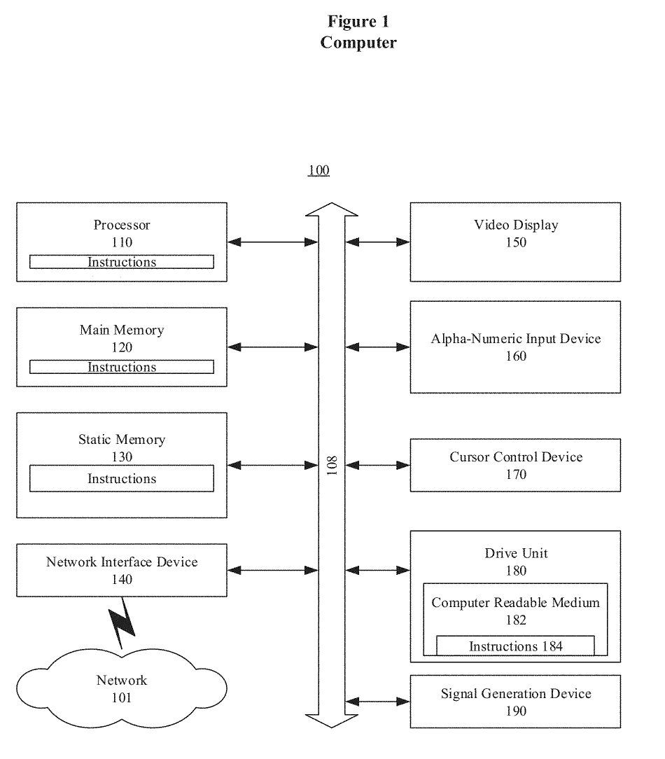

FIG. 1 is an illustrative embodiment of a general computer system, on which a method of location-based information distribution can be implemented, and which is shown and is designated 100. The computer system 100 can include a set of instructions that can be executed to cause the computer system 100 to perform any one or more of the methods or computer based functions disclosed herein. The computer system 100 may operate as a standalone device or may be connected, for example, using a network 101, to other computer systems or peripheral devices.

In a networked deployment, the computer system 100 may operate in the capacity of a server or as a client user computer in a server-client user network environment, or as a peer computer system in a peer-to-peer (or distributed) network environment. The computer system 100 can also be implemented as or incorporated into various devices, such as a stationary computer, a mobile computer, a personal computer (PC), a laptop computer, a tablet computer, a wireless smart phone, a personal digital assistant (PDA), a global positioning satellite (GPS) device, a communications device, a control system, a networked server, an application server, or any other machine capable of executing a set of instructions (sequential or otherwise) that specify actions to be taken by that machine. The computer system 100 can be incorporated as or in a particular device that in turn is in an integrated system that includes additional devices. In a particular embodiment, the computer system 100 can be implemented using electronic devices that provide voice, video or data communication. Further, while a single computer system 100 is illustrated, the term “system” shall also be taken to include any collection of systems or sub-systems that individually or jointly execute a set, or multiple sets, of instructions to perform one or more computer functions.

As illustrated in FIG. 1, the computer system 100 includes a processor 110. A processor for a computer system 100 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. A processor is an article of manufacture and/or a machine component. A processor for a computer system 100 is configured to execute software instructions in order to perform functions as described in the various embodiments herein. A processor for a computer system 100 may be a general purpose processor or may be part of an application specific integrated circuit (ASIC). A processor for a computer system 100 may also be a microprocessor, a microcomputer, a processor chip, a controller, a microcontroller, a digital signal processor (DSP), a state machine, or a programmable logic device. A processor for a computer system 100 may also be a logical circuit, including a programmable gate array (PGA) such as a field programmable gate array (FPGA), or another type of circuit that includes discrete gate and/or transistor logic. A processor for a computer system 100 may be a central processing unit (CPU), a graphics processing unit (GPU), or both. Additionally, any processor described herein may include multiple processors, parallel processors, or both. Multiple processors may be included in, or coupled to, a single device or multiple devices.

Moreover, the computer system 100 includes a main memory 120 and a static memory 130 that can communicate with each other via a bus 108. Memories described herein are tangible storage mediums that can store data and executable instructions, and are non-transitory during the time instructions are stored therein. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. A memory described herein is an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a removable disk, tape, compact disk read only memory (CD-ROM), digital versatile disk (DVD), floppy disk, blu-ray disk, or any other form of storage medium known in the art. Memories may be volatile or non-volatile, secure and/or encrypted, unsecure and/or unencrypted.

As shown, the computer system 100 may further include a video display unit 150, such as a liquid crystal display (LCD), an organic light emitting diode (OLED), a flat panel display, a solid state display, or a cathode ray tube (CRT). Additionally, the computer system 100 may include an input device 160, such as a keyboard/virtual keyboard or touch-sensitive input screen or speech input with speech recognition, and a cursor control device 170, such as a mouse or touch-sensitive input screen or pad. The computer system 100 can also include a disk drive unit 180, a signal generation device 190, such as a speaker or remote control, and a network interface device 140.

In a particular embodiment, as depicted in FIG. 1, the disk drive unit 180 may include a computer-readable medium 182 in which one or more sets of instructions 184, e.g. software, can be embedded. Sets of instructions 184 can be read from the computer-readable medium 182. Further, the instructions 184, when executed by a processor, can be used to perform one or more of the methods and processes as described herein. In a particular embodiment, the instructions 184 may reside completely, or at least partially, within the main memory 120, the static memory 130, and/or within the processor 110 during execution by the computer system 100.

In an alternative embodiment, dedicated hardware implementations, such as application-specific integrated circuits (ASICs), programmable logic arrays and other hardware components, can be constructed to implement one or more of the methods described herein. One or more embodiments described herein may implement functions using two or more specific interconnected hardware modules or devices with related control and data signals that can be communicated between and through the modules. Accordingly, the present disclosure encompasses software, firmware, and hardware implementations. Nothing in the present application should be interpreted as being implemented or implementable solely with software and not hardware such as a tangible non-transitory processor and/or memory.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionality as described herein, and a processor described herein may be used to support a virtual processing environment.

The present disclosure contemplates a computer-readable medium 182 that includes instructions 184 or receives and executes instructions 184 responsive to a propagated signal; so that a device connected to a network 101 can communicate voice, video or data over the network 101. Further, the instructions 184 may be transmitted or received over the network 101 via the network interface device 140.

As used herein, the term “source” refers to a source of content shared on a social network. The term “visitor” is used herein to refer to a visitor on the social network searching for content. An individual user may be both a source and a visitor on the social network, and the terms “source” and “visitor” therefore describe both a user and the role played by the user in any example in which the terms are used.

As described herein, a user in a social network can serve as a source of location-specific information, and visitors to the social network can identify the location-specific information and/or the source of the location-specific information based at least on the location. A social network that includes the source and visitors allows the visitors to identify the information and/or the source based on a variety of factors, starting with a location specified on an interactive electronic map.

A location of a mobile device can be identified automatically from global positioning satellite (GPS) information, wireless signal sources such as known wireless fidelity (WiFi) network locations or triangulated cellular towers. A location can alternatively be identified by information entered by a source. When content is captured or entered via the mobile device, the content can be correlated with the location in which the content is captured or entered. These features are detailed herein.

A location-based information distribution system can collect information from sources using the mobile devices, and correlate the locations with map information. For example, the location-based information distribution system can collect content via applications installed on the mobile devices, and translate GPS information or WiFi network locations into latitude and longitude positions. These features are detailed herein.

When visitors to the location-based information distribution system want to find information about a location, the visitors can start by identifying the location on an interactive electronic map. The visitors can narrow or broaden a search by zooming in or out on the electronic ma, and filter information by specifying additional information to use in a search. These features are detailed herein.

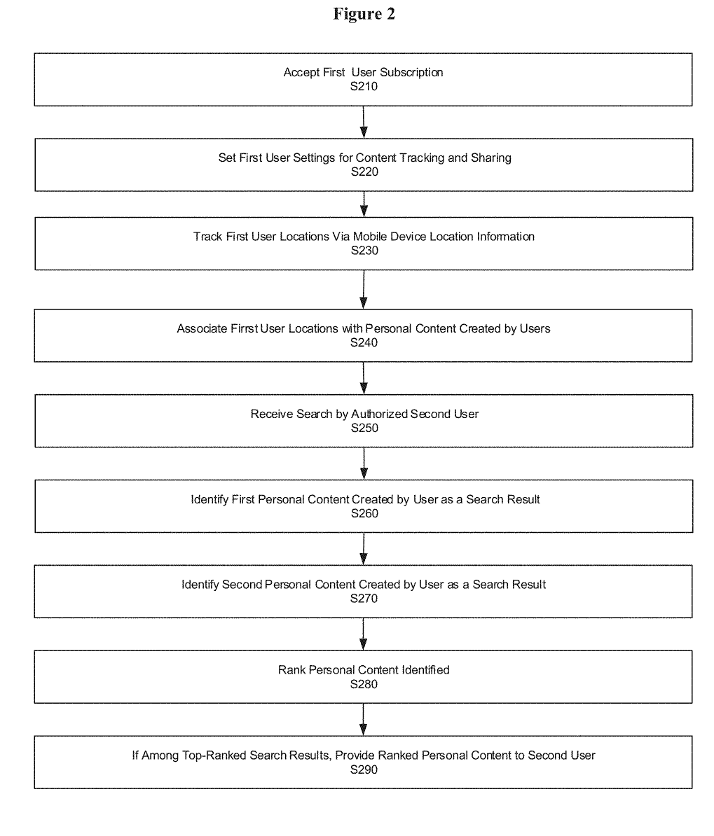

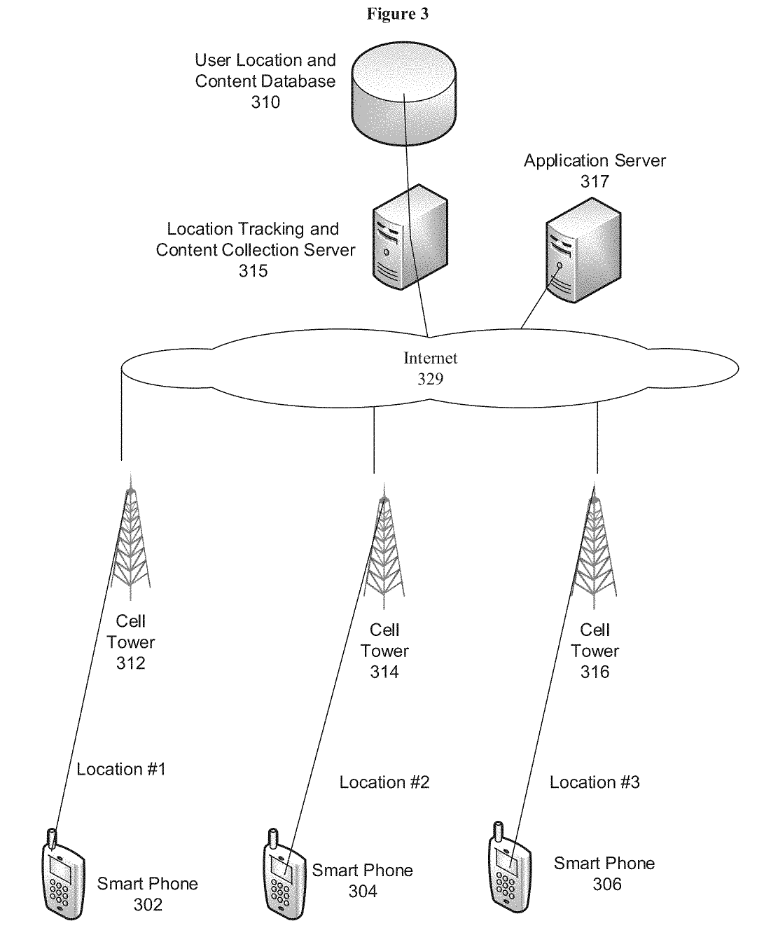

FIG. 2 shows an exemplary process for location-based information distribution, according to an aspect of the present disclosure. In FIG. 2, the process starts with a location-based information distribution system accepting a user subscription from a first user. The location-based information distribution system may include application servers (e.g., application server 317 in FIG. 3) which provide a location-based information distribution application to users over a communications network on request. The application allows users to enter subscription information via mobile devices or computers on which the application is installed. Alternatively, users can subscribe to the location-based information distribution system via webpages at an internet website.

A location-specific information distribution system provides an application for download and an internet site for visits. The location-specific information distribution system may store content and other information in a largescale data storage system, and process content and the other information in a largescale data processing system. The storage system and processing system may be provided by a cloud computing system with data centers that include numerous server computers and databases or other forms of memory.

Content that can be provided as location-specific information to a location-based information distribution system includes images, videos, statuses, and links. If allowed by a source, visitors can provide feedback on content such as comments or likes/dislikes. Additionally, images added by a source can be linked to other content, such as when the images are of the exterior or interior of a business. In this way, customers who are happy with, for example, a meal, or the interior of a hotel, can share a picture in a location-based information distribution system, and link the picture to the business that supplies the meal or interior. Sources can also link content to another entity (such as a business) by writing reviews/recommendations, and checking in to a location provided by the other entity.

At S220, user settings are set for the users who subscribe to the location-based information distribution system. User settings are for tracking and sharing information received or captured on a mobile device that includes a location-based information distribution application. For example, a user setting may be:
whether to track pictures taken using the mobile device with the application
whether to track social media posts, check-ins, comments etc. by the user
whether to track GPS or WiFi locations captured by the mobile device with the application
whether to track contact information, friend/follower/following information, and similar information of others detectable from the mobile device with the application
whether to share pictures taken using the mobile device with the application
whether to share social media posts, check-ins, comments etc. by the user
whether to share GPS or WiFi locations captured by the mobile device with the application
whether to share contact information, friend/follower/following information, and similar information of others detectable from the mobile device with the application

The location-based information distribution system may encourage sources to always or selectively authorize location collection, so that visitors can find them and/or interact with them. Additionally, the location-based information distribution system may restrict a visitor from finding sources or content from sources unless the visitors have themselves authorized location sharing for their own locations and content.

The settings for tracking and sharing may be at different levels of granularity, such as a blanket setting not to track or share any information of a type, or only to selectively track or share information of a type. When information is only to be selectively tracked or shared, the selectivity settings may be pre-set, or may be made dynamically. A dynamic selectivity setting may be made, for example, via a pop-up window on a screen that asks a source to selectively authorize tracking or sharing of one of the types of content noted herein.

A location-based information distribution system can collect many kinds of information about users and content. Besides locations correlated with content, other information that can be used to help visitors find content and/or sources include:
profile information in a profile of the source
profile information in a profile of the visitor(s)
the time the content is created
the time a visitor(s) performs a search by, e.g., specifying a location on a map
previous searches and selections of information (including location-specific information) by the visitor(s)
location-specific information entered by the visitor(s)
social network relationships between the source and visitors
social network relationships between the visitors and others
terminology used in content
frequency and (e.g., sudden) changes in frequency in creation of a particular type of content correlated to a particular location
frequency and (e.g., sudden) change in frequency in searches for a particular location searched on a map, or searches of a particular type or for particular content

The tracking of user locations may be performed in a variety of ways. For example, sources may be able to specify a location that will serve as their default location. In this way, a source can specify that their location is their city or neighborhood as a default, so that visitors searching for content in their city or neighborhood can find the user. Alternatively, sources may authorize real-time or near-real-time tracking, so that content shared by the source is associated with an actual location at which the content was captured or shared.

As an example of a search, a visitor may find a location on an interactive electronic map, and select the location. The visitor may select the location on the map using, for example, a cursor controlled by a mouse, or contact to a touch screen on which the map is displayed. A server that performs the search may use a predetermined radius around the selected location to search for content, and expand the radius when no content is found or when the user requests an expanded search. As described elsewhere herein, the location-based information distribution system may also present a visitor performing a search a free-form search tool to narrow the search, such as to particular topics or sources or keywords. The location-based information distribution system may also present a visitor performing a search with a list of choices, selectable by checkboxes, to narrow the search for content that starts with the location selected on the interactive electronic map.

Additionally, using the mapping tool of the location-based information distribution system described herein, a visitor can find sources who agree to be found on a virtual map, and communicate with the sources. For example, a visitor may select an icon on a map that appears after a search as described herein, and send a private message or e-mail to a source corresponding to the icon. Of course, sources may elect not to be made available to visitors by a variety of privacy settings, such as restrictions that prevent strangers from being able to send communications (but that allow friends or contacts to send communications).

At S230, user locations are tracked via location information captured by the mobile device. User locations may be identified from GPS, WiFi check-ins, social application check-ins, and other forms of identification location information. As noted above, user locations may be selectively tracked or always tracked, depending on authorizations made by the user.

At S240, user locations are associated with personal content created by the users (i.e., as sources). The user locations may be correlated in a location-based information distribution system database with personal content created by the sources. In this way, the system may associate a source's pictures with locations where they were taken, or comments on a social networking application with locations correlated to the comments. The locations may be correlated with content using the time and GPS/WiFi data corresponding to when the content is created, or using a location specified by the source. The source may specify the location at the time content is created, or after the content is created. Additionally, other users may specify a location for content when the source provides permission to do so. In any event, content is correlated with a location by, for example, longitude and latitudes, GPS coordinates, post office address, such that a visitor can find the content at least by searching for content by location.

Content created by users as described herein can include any type of content that is already provided via conventional social networks, including:
status updates
images
videos
events
links to external content available via the internet
information about items a source is offering for sale or for donation
information limited to a family circle or circle of friends

At S250, a search is received from a visitor different than the source who created the content in earlier steps. The search is received via, for example, an application installed on a mobile device, and at a server in a location-based information distribution system. Such a mobile device and server are shown in the embodiment of FIG. 3 described below. The search may be a search for a location, such as a town or neighborhood name. The search may also be for a type of content, such as a religious institution, school name, type of newsworthy incident, or other information pertinent to a location.

At S260, first personal content created by a source is identified as a search result, and at S270, second personal content created by a source is identified as a search result. The first personal content and second personal content may be created by different users. Additionally, more than two pieces of personal content may be identified as search results at S260 and S270.

At S280, the identified personal content is ranked, and at S290, top-ranked personal content is provided to the second (searching user). For example, a search may result in 5 items of personal content being retrieved. The search may also return one or more suggested topics to use as search parameters for a search, such as restaurants, gas stations, landmarks and so on. The suggested topics may vary based on the location specified in the search, so that a suggested topic for a search in an area with many historical features could be “landmarks” whereas a suggested topic for a search in an area with many culinary establishments could be “restaurants”.

FIG. 3 shows an exemplary network for location-based information distribution, according to an aspect of the present disclosure. In FIG. 3, smart phones 302, 304, 306 are representative of mobile devices that can be tracked by location. Locations can be tracked by GPS, Wireless Fidelity (WiFI) access point check-ins, social media check-ins, cellular tower locations, and other forms of location information that can be identified from information on a mobile device.

The location based information distribution system described herein can also identify devices used by sources that authorize the location-based information distribution system to collect and/or distribute information. For example, an application from the location-based information distribution system may be installed on a mobile device and receive authorization from the source to collect GPS information and picture information on the mobile device. Such an application may also receive authorization to collect contact information from the mobile device, including contact information from social network applications.

The location-based information distribution system can also obtain information about the devices including location and time. The location-based information system can receive information shared by a source using a device, and in response to receiving a search request specific to a location indicated on a geographic map, provide the information to the user performing the search.

In FIG. 3, each smart phone 302, 304, 306 is shown communicating via a separate cell tower 312, 314, 316 respectively. The disparate cell towers 312, 314, 316 are representative of dispersed geographical locations which can be used by mobile devices such as smart phones 302, 304, 306. Other forms of intermediaries for mobile devices can be used in FIG. 3, including WiFi access points.

In FIG. 3, the cell towers 312, 314, 316 are connected to the internet 329. The cell towers 312, 314, 316 typically receive wireless data signals from smart phones 302, 304, 306 and place data from the signals into the internet 329 over wired networks. Similarly, the cell towers 312, 314, 316 typically receive data signal from the internet 329, and forward data signals to smart phones 302, 304, 306.

A location-based information distribution system in FIG. 3 includes location tracking and content collection server 315, and user location and content database 310. The location tracking content collection server 315 is representative of network devices that receive information from smart phones 302, 304, 306, and process such information in the manner described herein, i.e., to allow visitors to search and find content based on geographic searches. The user location and content database 310 is representative of network storage devices that store the content, location information, and other forms of data received from smart phones 302, 304, 306.

FIG. 3 also shows an application server 317. Application server 317 is used to provide the location-based information distribution system application to requesting users. The application server 317 may also interact with applications once downloaded to mobile devices or computers used by requesting users. For example, application server 317 may store contact information for a source's contacts, profile information for each user using the application, and other information used to allow users to communicate via the application.

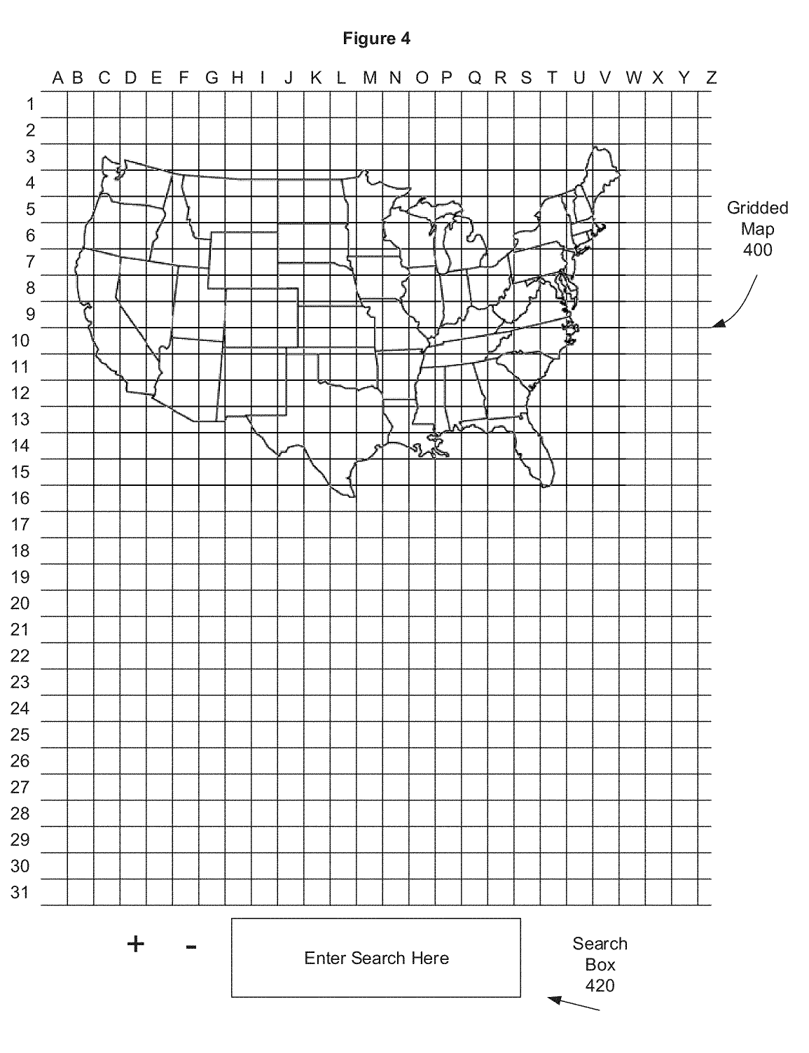

FIG. 4 shows an exemplary gridded map, according to an aspect of the present disclosure. In FIG. 4, a map of the United States is shown imposed on a grid in a gridded map 400. The gridded map 400 is an interactive electronic map that can be provided via a webpage or an application installed on a mobile device such as smart phones 302, 304, 306 in FIG. 3. The map allows a visitor to zoom in by, e.g., grid, state, or other geographic boundary, using a plus button shown at the bottom of the grid. The map also allows a visitor to zoom out using a minus (−) soft button shown at the bottom of the grid. The gridded map 400 is accompanied by a search box 420 that allows a visitor to enter, e.g., geographical terms, as the basis of a search of the location-based information distribution system described herein.

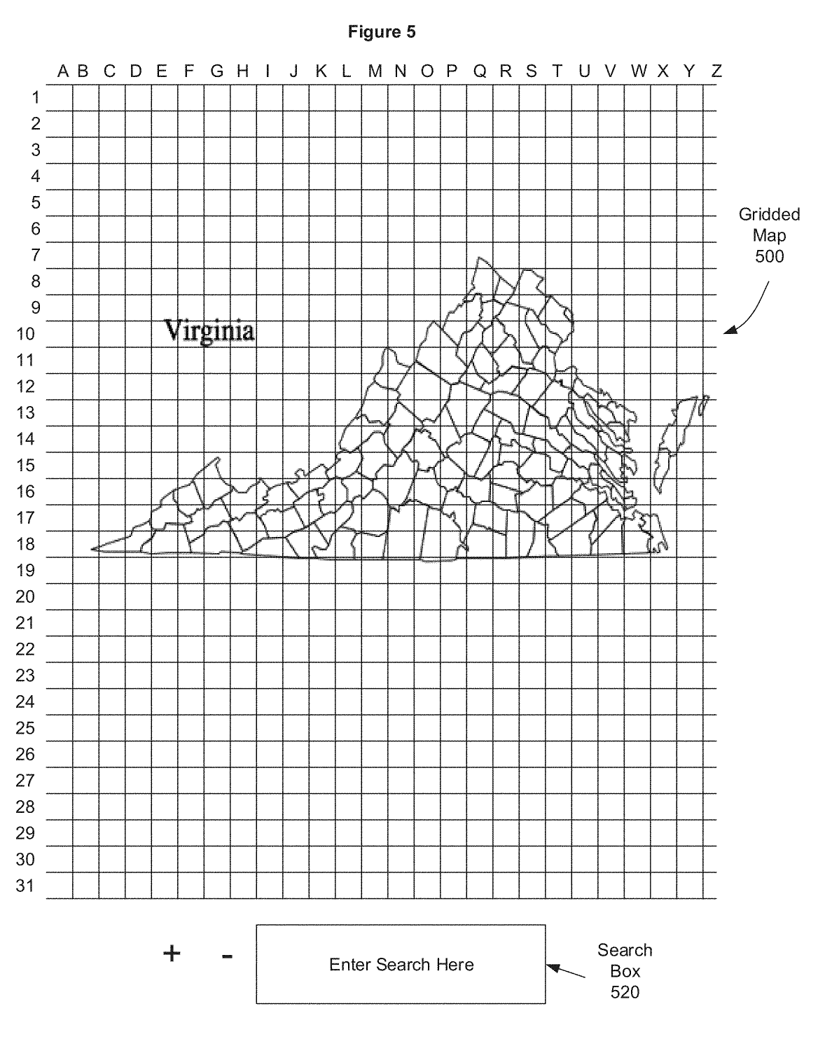

FIG. 5 shows another exemplary gridded map, according to an aspect of the present disclosure. In FIG. 5, a map of the state of Virginia in the United States is shown imposed on a grid in a gridded map 500. The gridded map 500 is an interactive electronic map that can be provided via a webpage or an application installed on a mobile device such as smart phones 302, 304, 306 in FIG. 3. The map allows a visitor to zoom in by, e.g., grid, state, or other geographic boundary, using a plus button shown at the bottom of the grid. The user can zoom in, for example, to counties or cities shown on the map. The map also allows a visitor to zoom out using a minus (−) soft button shown at the bottom of the grid. The user can zoom out, for example, to the map of the United States shown in FIG. 4. The gridded map 500 is accompanied by a search box 520 that allows a visitor to enter, e.g., geographical terms, as the basis of a search of the location-based information distribution system described herein.

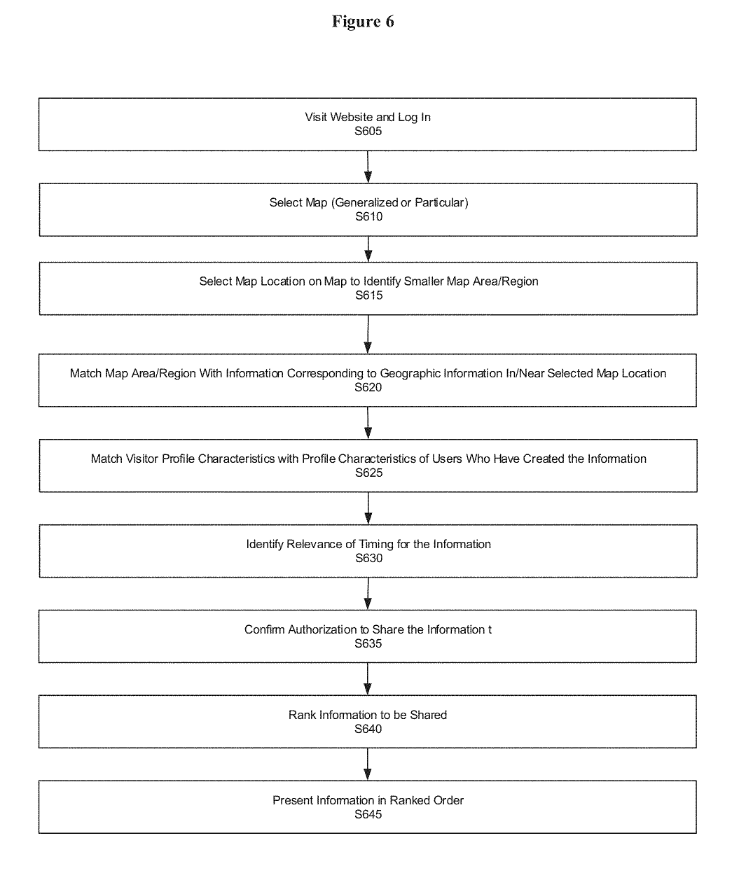

FIG. 6 shows an exemplary process for location-based information distribution, according to an aspect of the present disclosure. In FIG. 6, the process starts when a visitor visits a website and logs in at S605. At S610, the user selects a map that is either a generalized map or a particular map. A generalized map may be a map of the world, a column showing the shapes and names of all 7 continents, a column showing the shapes and names of all countries on a particular continent, and so on. A particular map may be a map that is focused on a particular area such as a country, state, county, city, region etc., and may be presented based on a search by the user who logs in, predetermined information previously set by the user who logs in, or a dynamic identification of the location (approximate) of the user who logs in using GPS or other location information.

At S615, the user selects a map location on the map to identify a smaller, more focused, area or region than shown in S610. The map may be automatically focused based on the selection at S615, and presented to the user on the webpage or via the application.

At S620, the selected map area, region (or other geographical selection) is matched with information corresponding to the geographic information in or near the map location selected at S615. In other words, a selection of a particular city by the user at S615 will result in the location-based information distribution system searching for information related to the particular city and stored in the location-based information distribution system, such as in user location and content database 310 in FIG. 3. The information may be identified by tags such as hashtags or location names or other geographic information.

As would be expected, for a large location-based information distribution system with numerous users, voluminous information may be stored and associated with a particular city or popular destination. At S625, profile characteristics of the visitor are matched with profile characteristics of users who created the information being matched at S620. This matching is done in order to filter information to find the information most likely to be useful to the visitor. The profile matching can be used together with particular parameters of a search entered by the visitor, so as to identify content likely to be of most interest to the visitor.

At S625, the process of FIG. 6 refers to profile characteristics. Though not required to identify which content to provide to a visitor, a source who provides content may have a folder on the location-based information management system. The folder may be a private folder where the user can save locations given high ratings by the user, locations of interest to the user, or locations of interest to visitors and noted to the user. The user can also store content of interest from visitors, such as from forums. The folder can also be used to store a record of events attended by the user, or for which the user plans to attend in the future. The location-based information distribution system may automatically store records of events including upcoming events, and may even be used remind the user of upcoming events.

At S630, relevance of timing is identified for the information. For example, for a location-based search for a newsworthy item such as a natural disaster, a presumption may be made that relevant content provided within the immediate past (e.g., most recent 5 minutes, 15 minutes, hour, day, week) is most relevant. However, for information related to long-ago events that would match a search, the presumption may be that recency is not so important. Rather, consideration may be given to the volume of content created in a short time period, or starting after a particular time in the past. Events that can be found using the location-based information distribution described herein may be many types of events including:
newsworthy events such as accidents or crimes or natural disasters
live events such as concerts
trade fairs
seminars
workshops

Consideration may also be given to popularity of the content, such as how many other visitors have selected to review the content. Other mechanisms for weighing which content to present can also be provided. However, as described herein, all content identified for a visitor in this embodiment is identified at least partly from the visitor selecting a map location in S615.

At S635, the location-based information distribution system confirms authorization to share a particular item of information. In this regard, usage restrictions associated with content may be imposed by the content creator, such as by restricting content to only friends or contacts of the content creator. Other forms of usage restrictions that may be followed can include bans on sharing photographs generally, bans on sharing status updates generally, bans on sharing particular photographs or status updates, and so on. If a particular item of information identified at S620 is not authorized for the visitor at S635, the information is not presented to the visitor. On the other hand, once a visitor is allowed to see content shared by a source, the visitor may also be notified of updates to the content. Visitors may also be allowed to follow an item of content, and comment on the item of content posted by a source.

At S640, information that is authorized, relevant, matched with the visitor, the selected map location, and the visitor's search parameters (if any), is ranked. At S645, the ranked information is presented to the visitor in ranked order via the webpage or application.

A location-based information distribution system may also allow visitors to join forums that are derivative of particular locations, areas, or items of content correlated to particular locations or areas. In this way, once a visitor finds content based (in whole or in part) on a map search as described herein, the visitor is provided the ability to create or join a forum that discusses the content or a topic involving the content. Topics may be indexed so that a similar topic may be available for discussion in multiple (or even most) areas. An example would be a topic for “schools” in an area, where topics involving schools may be the subject of forums in every area in which people live. Once in a forum, a visitor can be presented with topics and content filtered by:
time
relationship to the content creator
popularity or rating of the content
popularity or rating of the content's creator

Additionally, a location-based informational social network as described herein can provide additional features to connect sources and visitors, including:
internal (non-public) individual and group messaging
ability to create groups based on a particular topic for a location and/or based on users searching for the particular topic for the location
ability to follow and receive notifications for particular topics for a location
ability for a source to set an overall account or particular content to private or public
ability to create a profile as a personal page, and set information as public, private, or variably restricted to particular visitors
ability to connect through audio and video calls
ability to follow others and/or list others as friends and/or contacts
ability to create lists of users who provide location-based content on a particular topic
ability for entities to provide promotions that will appear based on searches for particular locations/areas and/or topics

The location-based information distribution system can also notify users with preexisting relationships when they are in the same location, such as by private message within a location-based information distribution system application. The map can be set to show icons such as for friends, contacts, followers etc., and each icon can be expanded to show a mechanism for a visitor to contact the corresponding friend, contact, followers by, for example, the private message within the application. As an example, when users are at the same event, they can then comment on the event, share posts, reply to comments, post pictures, and so on. Consistent with the entirety of the disclosure herein, the starting point for such interactions in this example is when a source identifies where they are on a map, and identifies the event they are attending.

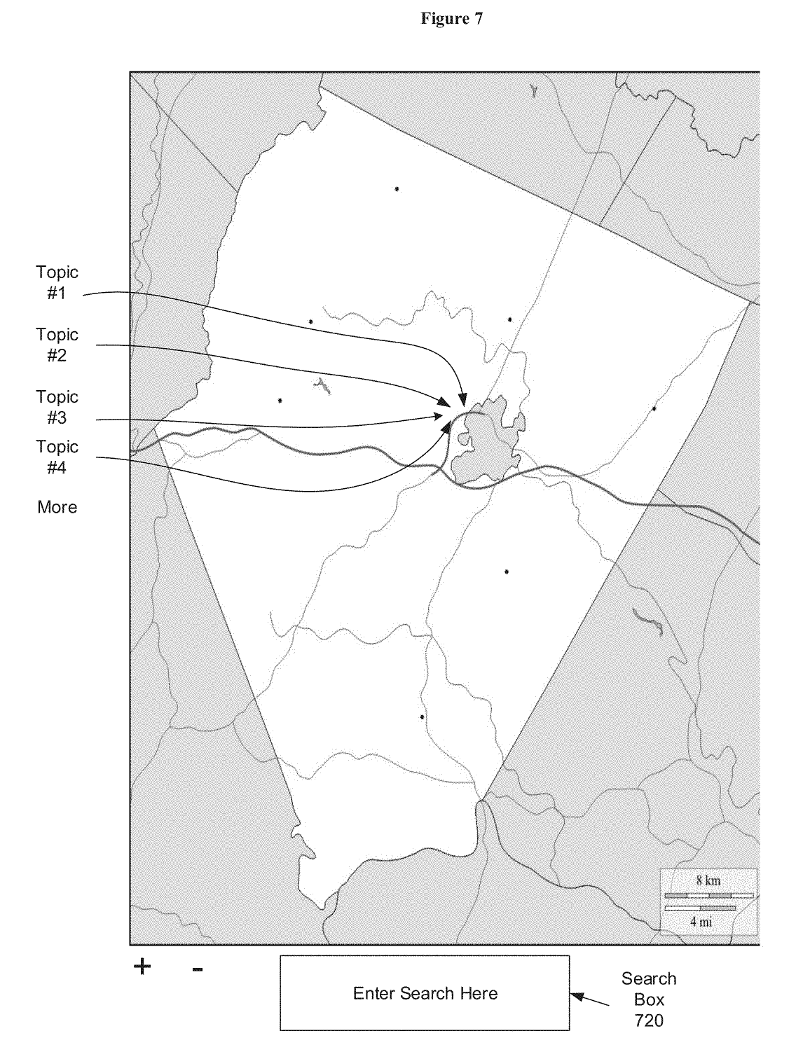

FIG. 7 shows an exemplary webpage for location-based information distribution, according to an aspect of the present disclosure. In FIG. 7, search results in a concentrated area around a location are shown as topic #1, topic #2, topic #3, topic #4, and “more”. The webpage also includes soft buttons to zoom in (“+”) and out (“−”). A search box 720 is provided for the user to refine or redo the search.

The topics shown in FIG. 7 are representative of the types of topics that can be searched and found using a system for location-based information distribution. Such topics might include items of interest for an area, such as:
landmarks and historical markers
coffeehouses
grocery stores
gas stations
restaurants and bars/taverns
houses of worship
visitor centers
beaches or public swimming pools
fishing spots
malls or individual retail locations

Of course, any number of topics may be of interest to visitors interested in a geographic area, and a process such as that shown in FIG. 6 can be used to filter content and topics returned to a visitor. Additionally, such filtered results can be continuously updated, and content provided to a visitor can show the sharing user's name, activity, location, update time etc.

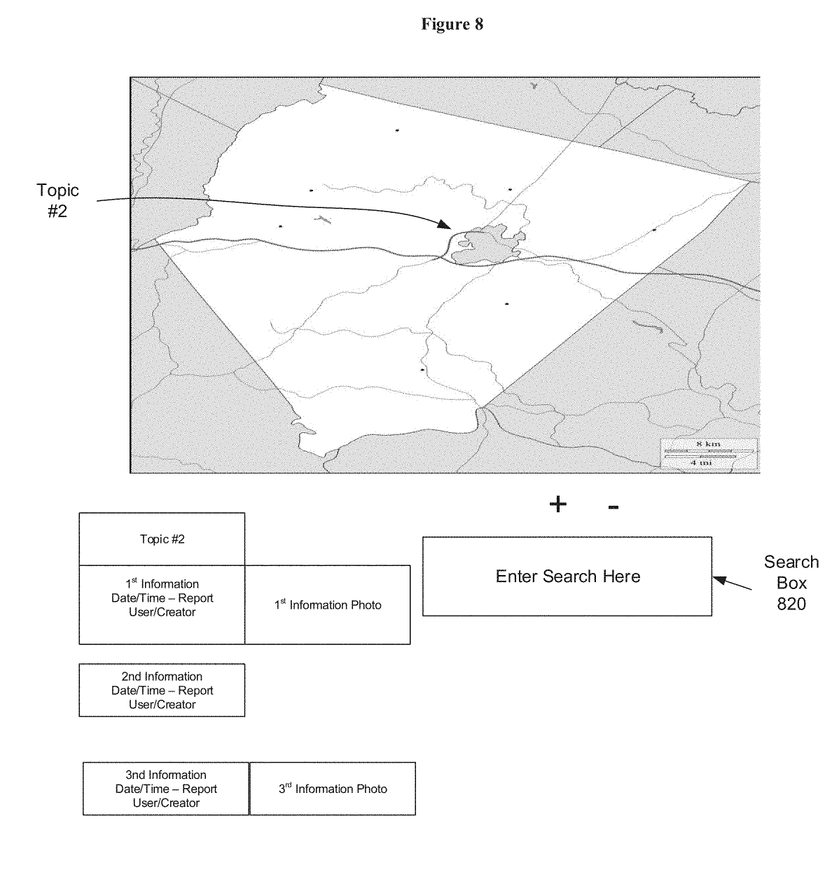

FIG. 8 shows an exemplary webpage for location-based information distribution, according to an aspect of the present disclosure. In FIG. 8, a selected topic is identified as topic #2. Once the user selects a topic, the location-based information distribution system can present items relating to the topic to the visitor. In FIG. 8, three different items of content are returned based on the visitor's search and selection, and the items include 1^{st} information, 2^{nd} information and 3^{rd} information.

Each of 1^{st} information, 2^{nd} information and 3^{rd} information include information of the date and time the information is created, comments such as a status report by the user/creator, and an identification of the user/creator. The 1^{st} information and 3^{rd} information each also include a photo.

FIG. 8 also includes a search box 820 for the visitor to use to refine or re-enter a search based on the map area. Alternatively, the user/visitor can zoom in (“+”) or out (“−”) using soft search buttons.

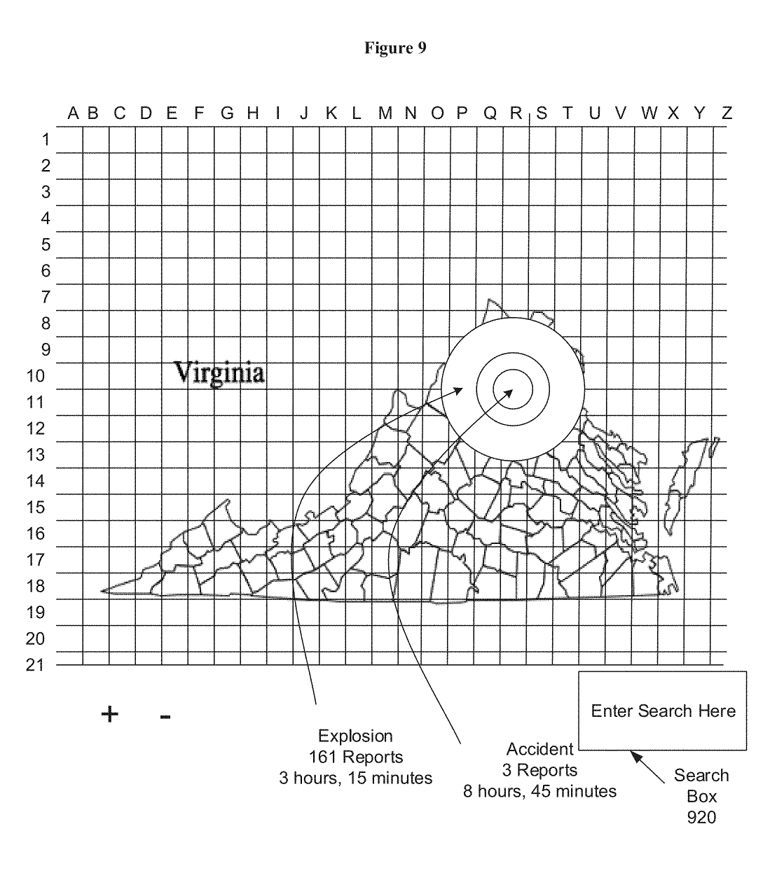

FIG. 9 shows an exemplary webpage for location-based information distribution, according to an aspect of the present disclosure. In FIG. 9, a gridded map of Virginia is shown with a series of expanded concentric circles superimposed thereon. A search box 920 is provided for a visitor to enter search terms, and search results are returned as reports shown below the gridded map. In FIG. 9, a map location search can be combined with search terms entered into the search box 920 to identify content that matches the search. When a local search does not return any content, or any content of interest to the visitor, the search area can be expanded outward to the next concentric circle, and so on. The map area can be zoomed in (“+”) and zoomed out (“−”).

In FIG. 9, one first topic returned by the location-based information distribution system is content under the topic of an “explosion” starting 3 hours and 15 minutes ago. The first topic has 161 reports which are instances of content provided by visitors. The second topic returned by the location-based information distribution system is content under the topic of an “accident” starting 8 hours and 45 minutes ago. The second topic has 3 reports which are instances of content provided by visitors.

Using a location-based information distribution system as described herein, a visitor can click on a map location and enter search terms to identify instances of content provided by users of the location-based information distribution system. The visitor can then find topics and items of content of interest, and from these can also identify visitors who might be of interest.

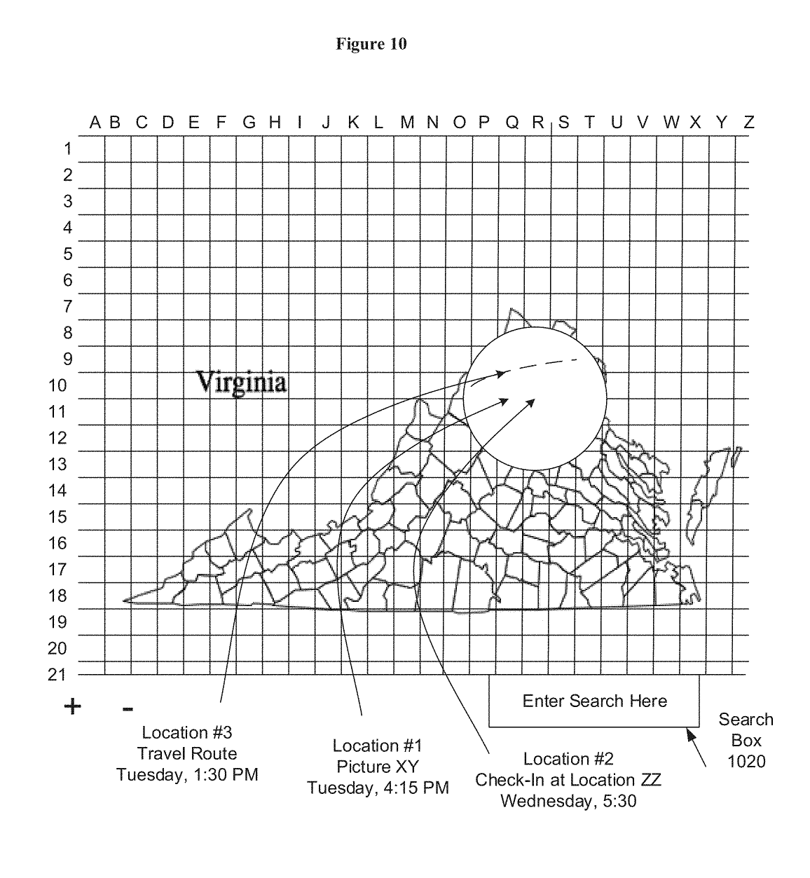

FIG. 10 shows an exemplary webpage for location-based information distribution, according to an aspect of the present disclosure. In FIG. 10, a gridded map of Virginia is shown, similar to the gridded map shown in FIG. 9. A search box 1020 is also shown for a visitor to enter search terms. In FIG. 10, content returned from the search is locations such as a travel route (shown by a series of dashes), a location at which a picture “XY” was taken, and a location at which a source checked-in to location ZZ. In FIG. 10, the information is all information of content provided by a single user who agrees to be tracked and to provide content to the location-based information distribution system for visitors to find when visiting. The information shown in FIG. 10 is merely exemplary, and many forms of information can be provided as content that can be correlated with a location and returned to visitors based on a search. Such content can include:
social media posts
pictures
check-ins
business reviews (also showing the business name, address, category of the business)
government office descriptions
post office locations
gas station locations
restaurant locations
landmarks and historical markers

Accordingly, as described herein users can agree to provide content either dynamically (piece by piece) or in advance (as types of content). Additionally, restrictions can be places on which visitors can obtain the content based on a search of the location-based information distribution system.

For the variety of locations that can be noted on a map, icons for the locations can be associated with content including check-ins, reviews, and other forms of content provided by individual users. When a visitor searching a map identifies a location, such as a business, the content presented to the visitor may be prioritized to show content from the visitor's friends and contacts first. For example, a business with 1750 reviews may have 5 reviews by friends and contacts of a visitor to a location-based information distribution application, and the 5 reviews will be presented first.

Businesses may also be recommended by a location-based information distribution service provider, based on popularity of the business, payments by the business to the location-based information distribution service provider for preferred placement on searched maps, and so on. For example, a visitor searching for food on a map may be shown restaurant recommendations that reflect:
the user's previous restaurant visits and presumed food preferences
which restaurants a visitor's friends and contacts have visited and favorably reviewed
which restaurants have the highest ratings
which restaurants have paid the service for preferably placement on the map
proximity of the visitor to the restaurants

Additionally, visitors can obtain content of interest by clicking on a map, and having the click transformed into a search for items of content that are nearby, that match the visitor's profile characteristics, and/or that match the visitor's search parameters. In this way, visitors can obtain unique content from users of the location-based information distribution system based on location.

Accordingly, location-based information distribution enables a source to share content, and visitors to obtain content. Content can be shared in accordance with preferences of content creator. Similarly, a visitor can obtain the content in accordance with profile information provided directly by the visitor, and history of the visitor from using the location-based information distribution system. The location-based information distribution system can provide as a supplemental service a trip management tool, to help visitors organize and manage trips. The visitor's preferences and history can be used by the system to identify content to present to the visitor in the future. The visitors can also refer to the history maintained by the location-based information distribution system in order to manage itineraries, and retrieve records and information of locations to which they travelled, statuses they shared, and photos and videos they took, along with the locations and times the content was created. Additionally, a source who creates content can affirmatively share content such as trip information and or pictures with visitors.

Although location-based information distribution has been described with reference to several exemplary embodiments, it is understood that the words that have been used are words of description and illustration, rather than words of limitation. Changes may be made within the purview of the appended claims, as presently stated and as amended, without departing from the scope and spirit of location-based information distribution in its aspects. Although location-based information distribution has been described with reference to particular means, materials and embodiments, location-based information distribution is not intended to be to the particulars disclosed; rather location-based information distribution extends to all functionally equivalent structures, methods, and uses such as are within the scope of the appended claims.

For example, several different examples are provided herein for how a visitor can search a map to begin identifying relevant content around a location. However, the location-based information distribution system can also be used to plan a series of events such as a multi-day trip. For example, a visitor can select a destination and the system will filter content relating to the destination based on the visitor's history, the visitor's profile, the visitor's specific search parameters, and so on. The visitor may also be provided the ability to specify dates in advance, so that the system can list events that will take place in and around the specified location during the trip.

In the example above, once a visitor plans a route on the location-based information distribution system, the system can provide recommendations such as by recommending services available en route, and listing location information for selected locations. Visitors may also submit search requests and ask visitors to help arrange services along the route. The visitors can then partner with the visitors and provide, for example, business services to the visitor. The partners can send a business profile and offer the visitor a deal to try out a service. Once the visitor agrees to use a service from a partner, the location-based information distribution system can provide all of the partner's information for the service including address, services (food, lodges, rest areas, and gas station), ratings of visitors, reviews of visitors about its quality, and list of users' friends who might have used the service.

Additionally, entities such as businesses, local governments or individuals can add a location to a map used by the location-based information distribution system. A location can be added when the entity first joins the system by downloading an application and registering. An individual can add an entity that is not already in the system when the individual first uses services provided by the entity in a location. When a business wants to promote services, the business can register the location and information in order to promote services. The system provider may even accept advertising from businesses associated with specific locations and areas, when the businesses want to promote services to visitors. The system may use visitor search requests to proactively recommend or pop up locations/services to users and create static, animated or interactive banner ads.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

The illustrations of the embodiments described herein are intended to provide a general understanding of the structure of the various embodiments. The illustrations are not intended to serve as a complete description of all of the elements and features of the disclosure described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

According to an aspect of the present disclosure, a method of matching geographic information to a requester includes matching users subscribed to a service with devices used for the service by the users. The method also includes receiving, from the devices, geographic information corresponding to locations of the users, and storing the geographic information. The method further includes receiving content selectively authorized by the users to be shared by the service, and matching the content selectively authorized by the users with the geographic information corresponding to the locations of the users. The method also includes receiving from a requester a request specific to a location indicated on an electronic map and, in response to the request, identifying from the content selectively authorized by the users to be shared by the service and based on matched geographic information that matches the location indicated on the electronic map, a subset of the content to provide to the requester in response to the request. The method concludes with providing, over a communications network, the subset of the content to provide to the requester in response to the request and based on the geographic information that matches the location indicated on the electronic map.

According to another aspect of the present disclosure, the method further includes tracking movements of the devices used for the service in accordance with authorizations from the users subscribed to the service.

According to yet another aspect of the present disclosure, the method further includes correlating locations determined from movements of the devices being tracked with times the devices are at the locations.

According to another aspect of the present disclosure, the method further includes automatically correlating unique content entered by users with locations determined from movements of the devices and times the devices are at the locations determined.

According to yet another aspect of the present disclosure, the method further includes providing an electronic map to the requester, and receiving from the requester an indication of a location on the electronic map as a search request.

According to still another aspect of the present disclosure, the method further includes searching for unique content entered by users and correlated with locations closest to the location on the electronic map entered by the requester.

According to another aspect of the present disclosure, the method further includes comparing profile information of the requester with the unique content entered by the users to identify unique content relevant to the requester.

According to yet another aspect of the present disclosure, the method further includes comparing profile information of the requester with profile information of the users to identify users matching the profile information of the requester.

According to still another aspect of the present disclosure, the method further includes identifying unique content provided by users with profile information matching the profile information of the requester.

According to another aspect of the present disclosure, the method further includes ranking the unique content identified using a scoring system to identify unique content most likely to be of interest to the requester.

According to yet another aspect of the present disclosure, the method further includes filtering the ranked unique content to present to the requester only the identified unique content having highest scores.

According to still another aspect of the present disclosure, the method further includes customizing topics to present to the requester based on a user profile of the requester.

According to another aspect of the present disclosure, the method further includes identifying topics in unique content that matches the geographic information, ranking the identified topics to identify highest ranked topics for the location indicated on the electronic map, and presenting highest ranked topics to the requester.

According to another aspect of the present disclosure, the identified topics are ranked based on frequency the topics appear in unique content entered by the users.

According to yet another aspect of the present disclosure, the identified topics are ranked based on how recently the topics appeared in unique content entered by the users.

According to still another aspect of the present disclosure, the identified topics are ranked based on information obtained from external media sources.

According to another aspect of the present disclosure, the method further includes searching a radius around the location indicated on the electronic map for unique content entered by users at locations within the radius.

According to yet another aspect of the present disclosure, the method further includes expanding the radius around the location to find more unique content entered by users.

According to an aspect of the present disclosure, a tangible non-transitory computer readable storage medium stores a computer program. The computer program, when executed by a processor, causes a computer apparatus to perform a process. The process includes matching users subscribed to a service with devices used for the service by the users. The process also includes receiving, from the devices, geographic information corresponding to locations of the users, and storing the geographic information. The process further includes receiving content selectively authorized by the users to be shared by the service, and matching the content selectively authorized by the users with the geographic information corresponding to the locations of the users. The process also includes receiving from a requester a request specific to a location indicated on an electronic map and, in response to the request, identifying from the content selectively authorized by the users to be shared by the service and based on matched geographic information that matches the location indicated on the electronic map, a subset of the content to provide to the requester in response to the request. The process concludes with providing, over a communications network, the subset of the content to provide to the requester in response to the request and based on the geographic information that matches the location indicated on the electronic map.

According to an aspect of the present disclosure, a computer apparatus includes a memory that stores instructions, and a processor that executes the instructions. When executed by the processor, the instructions cause the processor to perform operations. The operations include matching users subscribed to a service with devices used for the service by the users. The operations also include receiving, from the devices, geographic information corresponding to locations of the users, and storing the geographic information. The operations further include receiving content selectively authorized by the users to be shared by the service, and matching the content selectively authorized by the users with the geographic information corresponding to the locations of the users. The operations also include receiving from a requester a request specific to a location indicated on an electronic map and, in response to the request, identifying from the content selectively authorized by the users to be shared by the service and based on matched geographic information that matches the location indicated on the electronic map, a subset of the content to provide to the requester in response to the request. The operations conclude with providing, over a communications network, the subset of the content to provide to the requester in response to the request and based on the geographic information that matches the location indicated on the electronic map.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The preceding description of the disclosed embodiments is provided to enable any person skilled in the art to make or use the present disclosure. As such, the above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method of matching geographic information to a requester, comprising:
matching users subscribed to a service with devices used for the service by the users;
receiving, from the devices, geographic information corresponding to locations of the users, and storing the geographic information;
receiving content selectively authorized by the users to be shared by the service, and matching the content selectively authorized by the users with the geographic information corresponding to the locations of the users;
receiving from a requester a request specific to a location indicated on an electronic map and, in response to the request, identifying from the content selectively authorized by the users to be shared by the service and based on matched geographic information that matches the location indicated on the electronic map, a subset of the content to provide to the requester in response to the request; and
providing, over a communications network, the subset of the content to provide to the requester in response to the request and based on the geographic information that matches the location indicated on the electronic map.

2. The method of claim 1, further comprising:
tracking movements of the devices used for the service in accordance with authorizations from the users subscribed to the service.

3. The method of claim 2, further comprising:
correlating locations determined from movements of the devices being tracked with times the devices are at the locations.

4. The method of claim 3, further comprising:
automatically correlating unique content entered by users with a location determined from movements of the devices and a time the device is at the location determined.

5. The method of claim 1, further comprising:
providing an electronic map to the requester, and receiving from the requester an indication of a location on the electronic map as a search request.

6. The method of claim 5, further comprising
searching for unique content entered by users and correlated with locations closest to the location on the electronic map entered by the requester.

7. The method of claim 6, further comprising:
comparing profile information of the requester with the unique content entered by the users to identify unique content relevant to the requester.

8. The method of claim 6, further comprising:
comparing profile information of the requester with profile information of the users to identify users matching the profile information of the requester.

9. The method of claim 8, further comprising:
identifying unique content provided by users with profile information matching the profile information of the requester.

10. The method of claim 9, further comprising:
ranking the unique content identified using a scoring system to identify unique content most likely to be of interest to the requester.

11. The method of claim 10, further comprising:
filtering the ranked unique content to present to the requester only the identified unique content having highest scores.

12. The method of claim 1, further comprising:
customizing topics to present to the requester based on a user profile of the requester.

13. The method of claim 1, further comprising:
identifying topics in unique content that matches the geographic information;
ranking the identified topics to identify highest ranked topics for the location indicated on the electronic map, and
presenting highest ranked topics to the requester.

14. The method of claim 13,
wherein the identified topics are ranked based on frequency the topics appear in unique content entered by the users.

15. The method of claim 13,
wherein the identified topics are ranked based on how recently the topics appeared in unique content entered by the users.

16. The method of claim 13,
wherein the identified topics are ranked based on information obtained from external media sources.

17. The method of claim 1, further comprising:
searching a radius around the location indicated on the electronic map for unique content entered by users at locations within the radius.

18. The method of claim 17, further comprising:
expanding the radius around the location to find more unique content entered by users.

19. A tangible non-transitory computer readable storage medium that stores a computer program, the computer program, when executed by a processor, causing a computer apparatus to perform a process comprising:
matching users subscribed to a service with devices used for the service by the users;
receiving, from the devices, geographic information corresponding to locations of the users, and storing the geographic information;
receiving content selectively authorized by the users to be shared by the service, and matching the content selectively authorized by the users with the geographic information corresponding to the locations of the users;
receiving from a requester a request specific to a location indicated on an electronic map and, in response to the request, identifying from the content selectively authorized by the users to be shared by the service and based on matched geographic information that matches the location indicated on the electronic map, a subset of the content to provide to the requester in response to the request; and
providing, over a communications network, the subset of the content to provide to the requester in response to the request and based on the geographic information that matches the location indicated on the electronic map.

20. A computer apparatus, comprising:
a memory that stores instructions, and
a processor that executes the instructions,
wherein, when executed by the processor, the instructions cause the processor to perform operations comprising:
matching users subscribed to a service with devices used for the service by the users;
receiving, from the devices, geographic information corresponding to locations of the users, and storing the geographic information;
receiving content selectively authorized by the users to be shared by the service, and matching the content selectively authorized by the users with the geographic information corresponding to the locations of the users;
receiving from a requester a request specific to a location indicated on an electronic map and, in response to the request, identifying from the content selectively authorized by the users to be shared by the service and based on matched geographic information that matches the location indicated on the electronic map, a subset of the content to provide to the requester in response to the request; and
providing, over a communications network, the subset of the content to provide to the requester in response to the request and based on the geographic information that matches the location indicated on the electronic map.
